(19) United States
(12) Patent Application Publication
(10) Pub. No.: US 2012/0153218 A1
(43) Pub. Date: Jun. 21, 2012

(54) POLISHING COMPOSITION

(75) Inventors: Tatsuhiko HIRANO, Kiyosu-shi (JP); Hiroshi Mizuno, Kiyosu-shi (JP); Takahiro Umeda, Kiyosu-shi (JP)

(73) Assignee: Fujimi Incorporated, Kiyosu-shi (JP)

(21) Appl. No.: 13/407,633

(22) Filed: Feb. 28, 2012

Related U.S. Application Data
(63) Continuation of application No. 12/340,971, filed on Dec. 22, 2008, now abandoned.

(30) Foreign Application Priority Data
Dec. 28, 2007 (JP) 2007-339490

(51) Int. Cl. C09K 13/06

(52) U.S. Cl. 252/79.1

(57) ABSTRACT

To provide a polishing composition which can satisfy both suppression of the surface topography and a high stock removal rate, in a polishing step in the production of a wiring structure.

A polishing composition comprising abrasive grains, a processing accelerator, a dishing inhibitor and water. Here, the abrasive grains comprise at least first abrasive grains and second abrasive grains; the ratio of an average primary particle size D_{L1} of the second abrasive grains to an average primary particle size D_{S1} of the first abrasive grains, D_{L1}/D_{S1}, is 5>D_{L1}/D_{S1}>1; the degree of association of the first abrasive grains is from 1.8 to 5; and the degree of association of the second abrasive grains is at most 2.5.

### BACKGROUND OF THE INVENTION

1. Field of the Invention

The present invention relates to a polishing composition. More specifically, the present invention relates to a polishing composition to be used in a polishing step for forming e.g. a semiconductor device.

2. Discussion of Background

In recent years, along with the progress in the integration and speed of ULSI, etc. to be used for computers, a design rule of semiconductor devices has been progressively refined. To cope with an increase in electrical resistance of wiring due to such refinement of a wiring structure of a semiconductor device, it is considered to use a metal material containing copper, as a wiring material.

When a metal material containing copper is used as a wiring material, formation of a wiring structure by anisotropic etching is difficult due to the nature of the metal material. Therefore, it is common that such a wiring structure is formed by e.g. a method using chemical mechanical polishing (hereinafter referred to as a CMP method). Specifically, the following method is used. First, a barrier film made of tantalum or a tantalum-containing compound such as tantalum nitride, or a titanium compound or a ruthenium compound, is formed on an insulation film having wiring trenches engraved on its surface. Then, a conductor film made of a metal material containing copper, is formed on the barrier film so as to, at least, completely fill the wiring trenches. Then, in the first polishing step, a part of the conductor film is polished. Further, in the second polishing step, the conductor film is polished until the barrier film is exposed at portions other than the wiring trenches. Furthermore, in the third polishing step, the barrier film is polished until the insulation film is exposed at portions other than the wiring trenches, thereby to form wiring portions in the wiring trenches.

Heretofore, as a polishing composition, one comprising an abrasive such as silicon dioxide and various additives, has been considered. However, in a polishing method as described above, a conventional polishing composition was likely to polish a conductor film excessively, since it had a high stock removal rate against a metal material containing copper. In such a case, there was sometimes a problem of dishing observed on the polished surface after the polishing, i.e. a phenomenon such that the surface of the conductor film at portions corresponding to the wiring trenches, is recessed lower than the surface of the barrier film.

In order to solve such a problem, various techniques are considered. Patent Document 1 discloses a slurry for chemical mechanical polishing, which contains abrasive particles made of colloidal particles having a primary particle size of from 5 to 30 nm and having a degree of association of at most 5. The Document further discloses combining thereto second colloidal particles having a primary particle size of more than 20 nm. However, to according to the present inventors' study, such a slurry described in this Patent Document did not necessarily provide a high stock removal rate and had a room for an improvement of flatness. This is probably because the ratio or the degree of association of two different sizes of colloidal particles was not sufficiently adjusted.

Further, Patent Document 2 discloses a CMP method of polishing an object to be polished which has a barrier metal film and a conductor film. Such a method is to polish one object to be polished continuously by two types of polishing liquids which are ones comprising (1) particles having a primary particle size of from 20 to 50 nm and a degree of association of from 2 to 5, (2) an organic acid and (3) an oxidizing agent, and the two types of polishing liquids are ones containing particles having the same particle sizes.

Further, Patent Document 3 also discloses an abrasive comprising abrasive grains (A) having an average primary particle size in a range of from 5 to 300 nm and a degree of association in the abrasive in a range of from 1.5 to 5, an oxidizing agent (B), a protective film-forming agent (C), an acid (D), a basic compound (E) and water (F). According to the present inventors' study, with such a polishing composition containing one type of particles, as shown in each Patent Document, it is difficult to satisfy both properties such that the planarization characteristic is excellent, and the stock removal rate is not decreased even when an object to be polished has a modified layer such as an oxidized film formed on its surface. Further, as shown in Patent Document 3, when the abrasive grains having a primary particle size of at least 60 nm, are used, a planarization characteristic may sometimes be significantly deteriorated.
Patent Document 1: JP-A-2002-141314
Patent Document 2: JP-A-2007-227669
Patent Document 3: JP-A-2007-12679

### SUMMARY OF THE INVENTION

As mentioned above, with conventional polishing compositions, it has been impossible to satisfy both an improvement of the stock removal rate and reduction of the dishing, and it has been desired to develop a polishing composition which is capable of solving such a dilemma.

The polishing composition of the present invention is one comprising (a) abrasive grains, (b) a processing accelerator, (c) a dishing inhibitor and (d) water, wherein the abrasive grains comprise at least first abrasive grains and second abrasive grains; the ratio of an average primary particle size D_{L1} of the second abrasive grains to an average primary particle size D_{S1} of the first abrasive grains, D_{L1}/D_{S1}, is 5>D_{L1}/D_{S1}>1; the degree of association of the first abrasive grains is from 1.8 to 5; and the degree of association of the second abrasive grains is at most 2.5.

According to the present invention, in a polishing step in the production of a wiring structure, it is possible to suppress formation of difference in level on is the surface (surface topography) and also to obtain a suitable stock removal rate.

### DETAILED DESCRIPTION OF THE PREFERRED EMBODIMENTS POLISHING COMPOSITION

### (a) Abrasive Grains

The abrasive grains to be used in the polishing composition of the present invention, may be selected from conventionally known optional ones, but specifically, they are preferably at least one type selected from the group consisting of silicon dioxide, aluminum oxide, cerium oxide, zirconium oxide and titanium oxide.

The silicon dioxide includes colloidal silica, fumed silica and many other types different in the process for their production or in their properties.

Further, the aluminum oxide includes α-alumina, δ-alumina, θ-alumina, κ-alumina and other types different in form. Further, there is also one called fumed alumina from its production method.

The cerium oxide may, for example, be a trivalent or tetravalent one, depending on its oxidation number, and it may be of a hexagonal crystal system, a cubic crystal system or a face-centered cubic crystal system, depending on its crystal system.

The zirconium oxide may, for example, be of a monoclinic system, a tetragonal system or amorphous depending on its crystal system. Further, there is also one called fumed zirconia from its production method.

The titanium oxide includes titanium monoxide, dititanium trioxide, titanium dioxide and other ones depending on its crystal system. Further, there is also one called fumed titania from its production method.

For the composition of the present invention, it is possible to use them optionally or in combination if necessary. In the case of using them in combination, their combination or proportions to be used are not particularly limited. However, from the viewpoint of the effects of the present invention and of economic efficiency or availability, silicon dioxide is preferred, and colloidal silica is particularly preferred. Further, as mentioned below, the abrasive grains of the present invention are used in a form of a mixture of the first abrasive grains and the second abrasive grains, and both of them are preferably colloidal silica.

In the present invention, the abrasive grains comprise at least the first abrasive grains and the second abrasive grains. Here, the first abrasive grains and the second abrasive grains are ones different in the average primary particle size. Such an average primary particle size is calculated from the specific surface area by a BET method (a nitrogen adsorption method). Further, the abrasive grains are associated in the composition to form secondary particles, and the average secondary particle size of such secondary particles can be measured by a dynamic light scattering method. The abrasive grains used in the polishing composition of the present invention are characterized by the average primary particle size, the average secondary particle size and the degree of association as their ratio.

First, the first abrasive grains are ones having a smaller average primary particle size than the second abrasive grains. The average primary particle size and the average secondary particle size of the first abrasive grains are referred to as D_{S1} and D_{S2}, respectively. D_{S1} is usually from 5 to 40 nm, preferably from 5 to 20 nm, further preferably from 7 to 15 nm. Here, D_{S1} is preferably at least 5 nm from the viewpoint that a metal layer, particularly a copper layer, is polished at a sufficient rate. On the other hand, it is preferably at most 40 nm from the viewpoint that the surface topography is suitably controlled.

Further, the degree of association, D_{S2}/D_{S1}, is from 1.8 to 5, preferably from 2.0 to 4, further preferably from 2.5 to 3.5. The degree of association is preferably high from the viewpoint that a metal layer is polished at sufficient rate. On the other hand, the degree of association is preferably low from the viewpoint that the surface topography is suitably controlled.

Further, the content of the first abrasive grains is usually from 0.1 to 10 wt %, preferably from 0.5 to 3 wt %, further preferably from 0.8 to 2 wt %, based on the total weight of the polishing composition. From the viewpoint that a metal layer, particularly a copper layer, is polished at a sufficient rate, it is preferably at least 0.1 wt %, and from the viewpoint that the production cost is suppressed, and that the surface topography is suitably controlled, it is preferably at most 10 wt %.

On the other hand, the average primary particle size and the average secondary particle size of the second abrasive grains are referred to as D_{L1} and D_{L2}, respectively, and as compared with the primary particle size D_{S1} of the first abrasive grains, their relationship is 5>D_{L1}/D_{S1}>1, preferably 4>D_{L1}/D_{S1}>2, further preferably 3.5>D_{L1}/D_{S1}>2.5. Such a ratio, D_{L1}/D_{S1}, of the average primary particle sizes is preferably large from the viewpoint that a sufficient stock removal rate is achieved in polishing the surface of an object to be polished wherein a modified layer such as an oxidized film is formed thereon, and in polishing a wafer having a pattern formed, and the average primary particle size is preferably small from the viewpoint that the surface topography is suitably controlled.

The degree of association, D_{L2}/D_{L1}, in the second abrasive grains is at most 2.5, preferably at most 2.2, further preferably at most 2.0. Such a degree of association is preferably small in order to suitably control the surface topography.

Further, the content of the second abrasive grains depends on the content of the first abrasive grains. The content of the second abrasive grains (abrasive grains having a larger average primary particle size) is preferably small, and based on the total weight of the abrasive grains, the content of the first abrasive grains is preferably at least 0.6, more preferably at least 0.9, most preferably at least 0.95. In other words, based on the total weight of the abrasive grains, the content of the second abrasive grains is preferably at most 0.4, more preferably at most 0.1, most preferably at most 0.05. From the viewpoint that a sufficient stock removal rate is achieved in polishing the surface of an object to be polished wherein a modified layer such as an oxidized film is formed thereon and in polishing a wafer after a pattern is formed thereon, the content of the first abrasive grains is preferably large, and from the viewpoint that deterioration of the surface topography is suppressed, the content of the second abrasive grains is preferably large.

As mentioned above, in the present invention, it is possible to achieve good flatness and a high stock removal rate by using abrasive grains having a small average primary particle size and a degree of association of at least 1.8, and also, by using abrasive grains having a degree of association of at most 2.5, it is possible to prevent decrease of the stock removal rate of an object to be polished having a modified layer such as an oxidized film formed thereon or of a patterned wafer, without deteriorating the flatness.

### (b) Processing Accelerator

The polishing composition of the present invention further contains at least one processing accelerator. Such a processing accelerator is one to accelerate a stock removal rate of a metal layer, particularly a copper layer. Its action is to accelerate polishing of the metal layer by capturing metal ions generated by polishing.

Specific examples of the processing accelerator may, preferably, be a carboxylic acid and an amino acid from the viewpoint of excellent metal-capturing action and availability. The amino acid useful as the processing accelerator may, for example, be a neutral amino acid such as glycine, alanine, valine, leucine, isoluecine, alloisoluecine, serine, threonine, allothreonine, cysteine, methionine, phenylalanine, tryptophane, tyrosine, proline or cystine, a basic amino acid such as arginine or histidine, or an acidic amino acid such as glutamic acid or asparaginic acid. The carboxylic acid may, for example, be oxalic acid, citric acid, succinic acid, maleic acid, tartaric acid, 2-quinoline carboxylic acid (quinaldic acid), 2-pyridine carboxylic acid, 2,6-pyridine carboxylic acid or quinone. Among them, the most preferred is glycine.

The content of the processing accelerator in the polishing composition of the present invention is usually from 0.1 to 30 wt %, preferably from 0.5 to 2 wt %, further preferably from 0.5 to 1.5 wt %, based on the total weight of the polishing composition. From the viewpoint that a metal layer, particularly a copper layer, is polished at a sufficient rate, it is preferably at least 0.1 wt %, and from the viewpoint that the surface topography is suitably controlled, it is preferably at most 3 wt %.

### (c) Dishing Inhibitor

The polishing composition of the present invention further contains a dishing inhibitor. Such a dishing inhibitor suppresses formation of dishing by controlling the surface state of a metal layer, and at the same time, it has a function of preventing corrosion of the metal layer and adjusting the stock removal rate.

One type of the dishing inhibitor may, for example, be benzotriazole and its derivative, triazole and its derivative, tetrazole and its derivative, indole and its derivative, or imidazole and its derivative. The benzotriazole and its derivative also have a function to suppress corrosion of the surface by an oxidizing agent by acting on the surface of a metal layer.

As benzotriazole and its derivative useful in the present invention, various ones may be mentioned, but one represented by the following formula (III) is preferred:

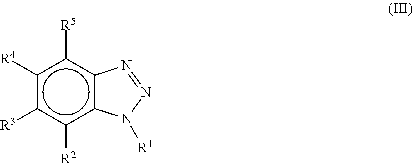

In the formula, R¹ is selected from the group consisting of hydrogen, an alkyl group, an alkyl group substituted with a carboxy group, an alkyl group substituted with a hydroxyl group and a tertiary amino group, and an alkyl group substituted with a hydroxyl group, and each of R² to R⁵ is independently one selected from the group consisting of hydrogen and a C₁₋₃ alkyl group.

Specific examples may be benzotriazole, 4-methyl-1H-benzotriazole, 5-methyl-1H-benzotriazole, 1-(2′,3′-dihydroxypropyl)benzotriazole, 1-(2′,3′-dihydroxypropyl)-4-methylbenzotriazole, 1-(2′,3′-dihydroxypropyl)-5-methylbenzotriazole, 1-[N,N-bis(hydroxyethyl)aminomethyl]benzotriazole, 1-[N,N-bis(hydroxyethyl)aminomethyl]-4-methylbenzotriazole, 1-[N,N-bis(hydroxyethyl)aminomethyl]-5-methylbenzotriazole, 1-hydroxymethyl-1H-benzotriazole, 1-hydroxymethyl-4-methyl-1H-benzotriazole, 1-hydroxymethyl-5-methyl-1H-benzotriazole, 3-(4-methyl-1H-benzotriazole-1-yl)butyric acid, 3-(5-methyl-1H-benzotriazole-1-yl)butyric acid, α-methyl-1H-benzotriazole-1-methanol, α-ethyl-1H-benzotriazole-1-methanol, α-isopropyl-1H-benzotriazole-1-methanol, 1H-benzotriazole-1-acetic acid, 1-(2-hydroxyethyl)-1H-benzotriazole, 1-[[bis(2-hydroxypropyl)amino]methyl-1H-benzotriazole and 4,5-dimethyl-1H-benzotriazole.

Among them, a preferred benzotriazole in the present invention is 1-[bis(2-hydroxyethyl)aminomethyl]-4-methylbenzotriazole, 1-[bis(2-hydroxyethyl)aminomethyl]-5-methylbenzotriazole, or their mixture.

The content of the protective film-forming agent in the polishing composition of the present invention is usually from 0.001 to 0.3 wt %, preferably from 0.01 to 0.1 wt %, further preferably from 0.02 to 0.05 wt %, based on the total weight of the polishing composition. From the viewpoint that the stock removal rate of the metal layer is properly suppressed, that dishing is sufficiently reduced, and that the surface topography is suitably controlled, it is preferably at least 0.001 wt %. On the other hand, it is preferably at most 0.3 wt % for not reducing the stock removal rate too much by excessively suppressing the stock removal rate of the metal layer.

Another type of dishing inhibitor used in the polishing composition of the present invention is a nonionic surfactant. Such a nonionic surfactant functions not only as a dishing inhibitor but also as a stock removal rate adjuster. The nonionic surfactant to be used in the present invention is one represented by the following formula (I):

R-POA (I)

wherein R is an alkyl group, and POA is a polyoxyalkylene chain selected from the group consisting of a polyoxyethylene chain, a polyoxypropylene chain and a poly(oxyethylene/oxypropylene) chain.

Here, in order to maintain the solubility in water and dispersibility of the abrasive grains to be good, POA is preferably a polyoxyethylene chain, R preferably has from 10 to 16 carbon atoms, and an HLB is preferably from 7 to 14. The polymerization degree of POA is preferably at most 12 in order to maintain the dispersibility of the abrasive grains to be good. Further, in the present invention, the HLB is one calculated by using Griffin formula:

HLB=((sum of formula weight of hydrophilic portion)/molecular weight)×20

Further, the content of the nonionic surfactant to be used as a dishing inhibitor in the polishing composition is usually from 0.0005 to 0.5 wt %, preferably from 0.01 to 0.2 wt %, further preferably from 0.02 to 0.1 wt %, based on the total weight of the polishing composition. From the viewpoint that a metal layer, particularly a copper layer, is polished at a sufficient rate, it is preferably at least 0.0005 wt %, and from the viewpoint that the surface topography is suitably controlled, it is preferably at most 0.5 wt %.

Another type of the dishing inhibitor used in the polishing composition of the present invention is an anionic surfactant. The anionic surfactant can be selected from conventionally known optional ones. However, one exhibiting a stronger dishing-suppression function by a combination with the nonionic surfactant may, for example, be an anionic surfactant represented by the following formula (IIa) or (IIb):

R′-A (IIa)

R′-POA′-A (IIb)

wherein R′ is a group selected from the group consisting of an alkyl group, an alkylphenyl group and an alkenyl group, POA′ is a polyoxyalkylene chain selected from the group consisting of a polyoxyethylene chain, a polyoxypropylene chain and a poly(oxyethylene/oxypropylene) chain, and A is an anionic functional group.

Here, more preferred is an anionic surfactant (IIb) containing a polyoxyalkylene chain.

The content of the anionic surfactant in the polishing composition of the present invention is usually from 0.005 to 0.1 wt %, preferably from 0.001 to 0.05 wt %, further preferably from 0.005 to 0.02 wt %, based on the total weight of the polishing composition. From the viewpoint that the surface topography is suitably controlled, it is preferably at least 0.0005 wt %. Further, from the viewpoint that a metal layer, particularly a copper layer, is polished at a sufficient rate, it is preferably at most 0.1 wt %.

### (d) Water

The polishing composition of the present invention contains water as a solvent to disperse or dissolve the respective components. Water is preferably water which does not contain impurities as far as possible with a view to suppressing hindrance to the actions of other components. Specifically, it is preferably pure water or ultrapure water wherein impurity ions are removed by an ion exchange resin followed by removing foreign objects by a filter, or distilled water.

### (e) Oxidizing Agent

The polishing composition of the present invention contains an oxidizing agent. Such an oxidizing agent is one having an action to accelerate polishing of the metal layer. The oxidizing agent may be at least one member selected from hydrogen peroxide, persulfuric acid, periodic acid, perchloric acid, peracetic acid, performic acid and nitric acid, and their salts. Hydrogen peroxide is preferred from the viewpoint that its cost is low and that it is possible to easily obtain one having a small amount of metal impurities.

The content of the oxidizing agent in the polishing composition of the present invention is preferably at least 0.3 wt %, more preferably at least 0.5 wt %, particularly preferably at least 0.75 wt %, based on the total weight of the polishing composition, from the viewpoint that a sufficient stock removal rate of the metal layer is obtained, and particularly that a high stock removal rate can be achieved also for an object to be polished where an altered layer such as an oxidized film is formed on the surface, or a wafer having patterns. On the other hand, the content of the oxidizing agent is preferably at most 5 wt %, more preferably at most 3 wt %, particularly preferably at most 1.5 wt %, from the viewpoint that the surface topography is suitably controlled.

### (h) Other Components

To the polishing composition of the present invention, it is possible to incorporate other components such as a chelating agent, a thickener, an emulsifier, an anti-corrosive agent, a preservative, a mildew proofing agent and an antifoaming agent, as the case requires, in accordance with information.

The polishing composition of the present invention is prepared by dissolving or dispersing the respective components in water. The method of dissolving or dispersing is optional, and the mixing order or mixing method of the respective components is not particularly limited.

The pH of the polishing composition of the present invention is not particularly limited, but it may be adjusted by adding a known acid or alkali. Its pH is preferably from 8 to 10, more preferably from 9 to 10, from the viewpoint that the good handling efficiency of the polishing composition is maintained.

The polishing composition of the present invention may be prepared, stored or transported, as a stock solution having a relatively high concentration, and it may be diluted for use at the time of actual polishing processing. The above-mentioned preferred concentration range is one at the time of actual polishing processing, and when such a method of use is employed. It is needless to say that in a state of being stored or transported, the solution will have a higher concentration.

Now, the present invention will be described with reference to Examples.

### Preparation of Polishing Compositions

Polishing compositions were prepared by blending colloidal silica as the abrasive grains, glycine as the processing accelerator, hydrogen peroxide as the oxidizing agent, an anionic surfactant, nonionic surfactant or benzotriazole compound, as the dishing inhibitor, as shown in Table 1.

TABLE 1

| | Abrasive grains 1 | | | Abrasive grains 2 | | | | Hydrogen | Anionic | | Nonionic | | Benzotriazole | |
|---|---|---|---|---|---|---|---|---|---|---|---|---|---|---|
| | | Degree | | | Degree | | Glycine | peroxide | surfactant | | surfactant | | compound | |
| | | of | Amount | | of | Amount | Amount | Amount | | Amount | | Amount | | Amount |
| | D_{S1} | association | added | D_{L1} | association | added | added | added | | added | | added | | added |
| | [nm] | [—] | (wt %) | [nm] | [—] | (wt %) | (wt %) | (wt %) | Type | (wt %) | Type | (wt %) | Type | (wt %) |
| Ex. 1 | 12 | 2.6 | 1.0 | 35 | 1.9 | 0.10 | 0.9 | 1.09 | A1 | 0.015 | B1 | 0.090 | E1 | 0.020 |
| Ex. 2 | 12 | 2.6 | 0.5 | 35 | 1.9 | 0.10 | 0.9 | 1.09 | A1 | 0.015 | B1 | 0.090 | E1 | 0.020 |
| Ex. 3 | 12 | 2.6 | 1.0 | 35 | 1.9 | 0.05 | 0.9 | 1.09 | A1 | 0.015 | B1 | 0.090 | E1 | 0.020 |
| Ex. 4 | 12 | 2.6 | 1.0 | 28 | 2.2 | 0.10 | 0.9 | 1.09 | A1 | 0.015 | B1 | 0.090 | E1 | 0.020 |
| Ex. 5 | 12 | 2.6 | 1.0 | 55 | 1.9 | 0.10 | 0.9 | 1.09 | A1 | 0.015 | B1 | 0.090 | E1 | 0.020 |
| Ex. 6 | 24 | 2.1 | 1.0 | 35 | 1.9 | 0.05 | 0.9 | 1.09 | A1 | 0.009 | B1 | 0.045 | E1 | 0.020 |
| Ex. 7 | 12 | 2.0 | 1.0 | 35 | 1.9 | 0.05 | 0.9 | 1.09 | A1 | 0.015 | B1 | 0.090 | E1 | 0.020 |
| Ex. 8 | 12 | 2.6 | 1.0 | 35 | 1.9 | 0.10 | 0.9 | 1.09 | A1 | 0.015 | B1 | 0.090 | E1 | 0.020 |
| Ex. 9 | 12 | 2.6 | 1.0 | 35 | 1.9 | 0.10 | 0.9 | 1.09 | A1 | 0.015 | B2 | 0.090 | E1 | 0.020 |
| Ex. 10 | 12 | 2.6 | 1.0 | 35 | 1.9 | 0.50 | 0.7 | 1.09 | A1 | 0.009 | B1 | 0.045 | E1 | 0.020 |
| Ex. 11 | 12 | 2.6 | 1.0 | 35 | 1.9 | 0.05 | 1.2 | 1.09 | A1 | 0.009 | B1 | 0.045 | E1 | 0.020 |
| Ex. 12 | 12 | 2.6 | 1.0 | 35 | 1.9 | 0.05 | 0.9 | 1.09 | A1 | 0.009 | B1 | 0.045 | E1 | 0.024 |
| Ex. 13 | 12 | 2.6 | 1.0 | 35 | 1.9 | 0.05 | 0.9 | 1.09 | A1 | 0.009 | B1 | 0.045 | E1 | 0.016 |
| Ex. 14 | 12 | 2.6 | 1.0 | 35 | 1.9 | 0.05 | 0.9 | 1.09 | A1 | 0.009 | B1 | 0.045 | E1 | 0.028 |
| Ex. 15 | 12 | 2.6 | 1.0 | 35 | 1.9 | 0.10 | 0.9 | 1.09 | A2 | 0.015 | B1 | 0.090 | E1 | 0.020 |
| Ex. 16 | 12 | 2.6 | 1.0 | 35 | 1.9 | 0.10 | 0.9 | 1.09 | A3 | 0.023 | B1 | 0.090 | E1 | 0.020 |
| Ex. 17 | 12 | 2.6 | 1.0 | 35 | 1.9 | 0.05 | 0.9 | 1.09 | A1 | 0.009 | B1 | 0.045 | E2 | 0.020 |
| Ex. 18 | 12 | 2.6 | 1.0 | 35 | 1.9 | 0.05 | 0.9 | 1.09 | A1 | 0.009 | B1 | 0.045 | E3 | 0.010 |
| Comp. | 12 | 2.6 | 1.0 | — | — | — | 0.9 | 1.09 | A1 | 0.009 | B1 | 0.045 | E1 | 0.024 |
| Ex. 1 | | | | | | | | | | | | | | |
| Comp. | 12 | 2.6 | 1.0 | — | — | — | 1.2 | 1.09 | A1 | 0.009 | B1 | 0.045 | E1 | 0.024 |
| Ex. 2 | | | | | | | | | | | | | | |
| Comp. | 12 | 2.6 | 1.0 | — | — | — | 1.2 | 1.09 | A1 | 0.009 | B1 | 0.045 | E1 | 0.024 |
| Ex. 3 | | | | | | | | | | | | | | |
| Comp. | 12 | 2.6 | 1.0 | 29 | 2.7 | 0.05 | 0.9 | 1.09 | A1 | 0.009 | B1 | 0.045 | E1 | 0.024 |
| Ex. 4 | | | | | | | | | | | | | | |
| Comp. | 12 | 2.6 | 1.0 | 70 | 1.9 | 0.10 | 0.9 | 1.09 | A1 | 0.015 | B1 | 0.090 | E1 | 0.020 |
| Ex. 5 | | | | | | | | | | | | | | |
| Comp. | 18 | 1.6 | 1.0 | 35 | 1.9 | 0.10 | 0.9 | 1.09 | A1 | 0.015 | B1 | 0.090 | E1 | 0.020 |
| Ex. 6 | | | | | | | | | | | | | | |
| Comp. | 20 | 1.7 | 1.0 | 35 | 1.9 | 0.10 | 0.9 | 1.09 | A1 | 0.015 | B1 | 0.090 | E1 | 0.020 |
| Ex. 7 | | | | | | | | | | | | | | |
| Comp. | 38 | 1.6 | 1.0 | 35 | 1.9 | 0.10 | 0.9 | 1.09 | A1 | 0.015 | B1 | 0.090 | E1 | 0.020 |
| Ex. 8 | | | | | | | | | | | | | | |
| Comp. | — | — | — | — | — | — | 0.9 | 1.09 | A1 | 0.008 | B1 | 0.045 | E1 | 0.022 |
| Ex. 9 | | | | | | | | | | | | | | |
| Comp. | 12 | 2.6 | 1.0 | 35 | 1.9 | 0.10 | — | 1.09 | A1 | 0.008 | B1 | 0.045 | E1 | 0.022 |
| Ex. 10 | | | | | | | | | | | | | | |
| Comp. | 12 | 2.6 | 1.0 | 35 | 1.9 | 0.10 | 0.9 | — | A1 | 0.008 | B1 | 0.045 | E1 | 0.022 |
| Ex. 11 | | | | | | | | | | | | | | |
| Comp. | 12 | 2.6 | 1.0 | 35 | 1.9 | 0.10 | 0.9 | 1.09 | — | — | B1 | 0.045 | E1 | 0.022 |
| Ex. 12 | | | | | | | | | | | | | | |
| Comp. | 12 | 2.6 | 1.0 | 35 | 1.9 | 0.10 | 0.9 | 1.09 | A1 | 0.008 | — | — | E1 | 0.022 |
| Ex. 13 | | | | | | | | | | | | | | |
| Comp. | 12 | 2.6 | 1.0 | 35 | 1.9 | 0.10 | 0.9 | 1.09 | A1 | 0.008 | B1 | 0.045 | — | — |
| Ex. 14 | | | | | | | | | | | | | | |

A1: Ammonium polyoxyethylene (2.5) laurylether sulfate
A2: Ammonium laurylether sulfate
A3: Ammonium dodecylbenzene sulfonate
B1: Polyoxyethylene isotridecyl ether
B2: Polyoxyethylene isotridecyl ether
E1: 1-[bis(2-hydroxyethyl)aminomethyl]-4(or 5)-methylbenzotriazole
E2: 1-[N,N-bis(hydroxyethyl)aminomethyl]benzotriazole
E3: 1-hydroxymethyl-1H-benzotriazole

### Evaluation of Stock Removal Rate

By using the obtained polishing compositions, the stock removal rates were evaluated in accordance with the following polishing condition 1.

### Polishing Condition 1

Polishing machine: polishing machine for one side CMP (Relexion LK; manufactured by APPLIED MATERIALS, INC.)

Object to be polished: Cu blanket wafer (diameter: 300 mm)

Polishing pad: polyurethane lamination polishing pad (tradename: IC-1010, manufactured by Rohm and Haas Company)

Polishing pressure: 0.9 psi (=about 6.2 kPa)

Number of revolutions of platen: 100 rpm

Supplying rate of polishing composition: 300 ml/min

Number of revolutions of carrier: 100 rpm

### Calculation Formula for Stock Removal Rate

Stock removal rate [nm/min]=(thickness (nm) of blanket wafer before polishing−thickness (nm) of blanket wafer after polishing)÷polishing time (min)

The thickness of the Cu blanket wafer before and after the polishing processing was measured by using a sheet resistance measuring device (tradename: VR-120SD/8, manufactured by Hitachi Kokusai Electric Inc.). The obtained results are shown in Table 2. Further, it is usually considered that there is no practical problem if the stock removal rate is 300 nm/min.

### Measurement of Surface Topography

On the surface of a Cu patterned wafer, by using the polishing composition of each Example, polishing was carried out until the Cu residual film became 300 nm under the following polishing condition 2. After the above polishing, on the surface of the copper patterned wafer, polishing was carried out until the barrier film was exposed, by using the polishing composition of each Example, under the following polishing condition 3. Then, the dishing amount was measured in an isolated wiring portion of 100 μm in width on the copper patterned wafer after the second polishing, by using an atomic force microscope (tradename: WA-1300, manufactured by Hitachi Construction Machinery Co., Ltd.). The dishing amount was evaluated by 4 levels i.e. less than 15 nm (⊚), at least 15 nm and less than 30 nm (◯), at least 30 nm and less than 50 nm (Δ), and at least 50 nm (X). The obtained results are shown in Table 2.

### Polishing Condition 2

Polishing machine: polishing machine for one side CMP (Relexion LK; manufactured by APPLIED MATERIALS, INC.)

Object to be polished: Copper patterned wafer (754 musk pattern, film thickness: 1,000 Å, initial concave trenches: 5,000 Å, manufactured by SEMATECH)

Polishing pad: polyurethane lamination polishing pad (IC-1010, manufactured by Rohm and Haas Company)

Polishing pressure: 2 psi (=about 14 kPa)

Number of revolutions of platen: 100 rpm

Supplying rate of polishing composition: 200 ml/min

Number of revolutions of carrier: 100 rpm

### Polishing Condition 3

Polishing machine: polishing machine for one side CMP (Relexion LK; manufactured by APPLIED MATERIALS, INC.)

Object to be polished: Copper patterned wafer (754 musk pattern, film thickness: 1,000 Å, initial concave trenches: 5,000 Å, manufactured by SEMATECH)

Polishing pad: polyurethane lamination polishing pad (IC-1010, manufactured by Rohm and Haas Company)

Polishing pressure: 0.7 psi (=about 4.8 kPa)

Number of revolutions of platen: 100 rpm

Supplying rate of polishing composition: 300 ml/min

Number of revolutions of carrier: 100 rpm

### Evaluation of Stock Removal Rate of Cu Patterned Wafer

The surface of a Cu blanket wafer was polished by using the polishing composition of each Example under Polishing Condition 2 for 60 seconds to measure a stock removal rate of the Cu blanket wafer. Then, the surface of a Cu patterned wafer was polished until the Cu residual film became 300 nm by using the polishing composition of each Example under Polishing Condition 2. From the polishing time T1, a Cu polishing rate of the patterned wafer was calculated by the following calculation formula.

With respect to the stock removal rate of the Cu patterned wafer, a ratio of the stock removal rate obtained by the following calculation formula was evaluated by 3 levels i.e. at least 0.9 (⊚), at least 0.8 and less than 0.9 (◯), at least 0.6 and less than 0.8 (Δ), and less than 0.6 (X).

### Calculation Formula for Stock Removal Rate of Cu Patterned Wafer

Stock removal rate [nm/min]=stock removal of Cu patterned wafer (700 [nm])/polishing time (T1 [sec])×60

### Calculation Formula for Ratio of Stock Removal Rates

Ratio of stock removal rates=stock removal rate of is Cu patterned wafer [nm/min]/stock removal rate of Cu blanket wafer [nm/min]

TABLE 2

| | Stock removal | | Stock removal |
|---|---|---|---|
| | rate | | rate of Cu |
| | [nm/min] | Dishing | patterned wafer |
| Ex. 1 | 540 | Δ | ⊚ |
| Ex. 2 | 440 | Δ | ⊚ |
| Ex. 3 | 520 | Δ | ◯ |
| Ex. 4 | 500 | Δ | ⊚ |
| Ex. 5 | 520 | Δ | ⊚ |
| Ex. 6 | 330 | ◯ | ⊚ |
| Ex. 7 | 310 | ◯ | ◯ |
| Ex. 8 | 390 | ◯ | ⊚ |
| Ex. 9 | 550 | Δ | ◯ |
| Ex. 10 | 500 | ⊚ | ◯ |
| Ex. 11 | 600 | Δ | ⊚ |
| Ex. 12 | 430 | ⊚ | ⊚ |
| Ex. 13 | 550 | Δ | ⊚ |
| Ex. 14 | 350 | ◯ | ◯ |
| Ex. 15 | 320 | Δ | ⊚ |
| Ex. 16 | 530 | Δ | ⊚ |
| Ex. 17 | 340 | Δ | ◯ |
| Ex. 18 | 390 | Δ | ◯ |
| Comp. Ex. 1 | 120 | ◯ | X |
| Comp. Ex. 2 | 180 | ◯ | ⊚ |
| Comp. Ex. 3 | 370 | X | ⊚ |
| Comp. Ex. 4 | 460 | X | ⊚ |
| Comp. Ex. 5 | 510 | X | ⊚ |
| Comp. Ex. 6 | 280 | Δ | X |
| Comp. Ex. 7 | 40 | ◯ | X |
| Comp. Ex. 8 | 16 | Δ | X |
| Comp. Ex. 9 | 5 | — | — |
| Comp. Ex. 10 | 5 | — | — |
| Comp. Ex. 11 | 8 | — | — |
| Comp. Ex. 12 | 250 | X | ◯ |
| Comp. Ex. 13 | 190 | Δ | X |
| Comp. Ex. 14 | 850 | X | ◯ |

1-7. (canceled)

8. A method of polishing a wiring structure which comprises Cu wiring comprising:
polishing a wiring structure with a polishing composition comprising (a) abrasive grains, (b) a processing accelerator, (c) a dishing inhibitor and (d) water, wherein the abrasive grains comprise at least first abrasive grains and second abrasive grains; the ratio of an average primary particle size D_{L1} of the second abrasive grains to an average primary particle size D_{S1} of the first abrasive grains, D_{L1}/D_{S1}, is 5>D_{L1}/D_{S1}>1; the degree of association of the first abrasive grains is from 1.8 to 5; and the degree of association of the second abrasive grains is at most 2.5.

9. The method according to claim 8, wherein the weight ratio of the first abrasive grains to the total weight of the abrasive grains (a) is from 0.6 to less than 1.

10. The method according to claim 8, wherein the average primary particle size of the first abrasive grains is from 5 nm to less than 40 nm.

11. The method according to claim 8, which further comprises an oxidizing agent (e).

12. The method according to claim 8, wherein the dishing inhibitor (c) is at least one selected from the group consisting of benzotriazole and its derivative.

13. The method according to claim 8, wherein the dishing inhibitor is at least one selected from the group consisting of a nonionic surfactant represented by
R-POA (I)
(wherein R is an alkyl group, POA is a polyoxyalkylene chain selected from the group consisting of a polyoxyethylene chain, a polyoxypropylene chain and an (oxyethylene/oxypropylene) chain)
and an anionic surfactant represented by
R′-A (IIa) or
R′-POA′-A (IIb)
(wherein R′ is a group selected from the group consisting of an alkyl group, an alkylphenyl group and an alkenyl group, POA′ is a polyoxyalkylene chain selected from the group consisting of a polyoxyethylene chain, a polyoxypropylene chain and a poly(oxyethylene/oxypropylene) chain, and A is an anionic functional group).

14. The method according to claim 8, wherein the processing accelerator (b) is at least one member selected from the group consisting of a carboxylic acid and an amino acid.

15. The method according to claim 8, wherein said abrasive grains are at least one type selected from the group consisting of silicon dioxide, aluminum oxide, cerium oxide, zirconium oxide and titanium oxide.

16. The method according to claim 8, wherein the average primary particle size of the first abrasive grains is from 5 nm to 20 nm.

17. The method according to claim 8, wherein the average primary particle size of the first abrasive grains is from 7 nm to 15 nm.

18. The method according to claim 8, wherein the degree of association of the first abrasive grains is from 2.0 to 4.

19. The method according to claim 8, wherein the degree of association of the first abrasive grains is from 2.5 to 3.5.

20. The method according to claim 8, wherein a content of said first abrasive grains is from 0.1 to 10 wt. % based on the total weight of said polishing composition.

21. The method according to claim 8, wherein D_{L1}/D_{S1}, is 4>D_{L1}/D_{S1}>2.

22. The method according to claim 8, wherein D_{L1}/D_{S1}, is 3.5>D_{L1}/D_{S1}>2.5.

23. The method according to claim 8, wherein the degree of association of said second abrasive grains is at most 2.2.

24. The method according to claim 8, wherein the degree of association of said second abrasive grains is at most 2.0.

25. The method according to claim 8, wherein the weight ratio of the first abrasive grains to the total weight of the abrasive grains (a) is at least 0.9 to less than 1.

26. The method according to claim 8, wherein the weight ratio of the first abrasive grains to the total weight of the abrasive grains (a) is at least 0.95 to less than 1.

27. The method according to claim 8, wherein said processing accelerator is present in amount of from 0.1 to 30 wt. %.
